(19) United States
(12) Patent Application Publication
(10) Pub. No.: US 2011/0043032 A1
(43) Pub. Date: Feb. 24, 2011

(54) VEHICLE WIRE HARNESS PORTION STRUCTURE

(75) Inventors: Hitoshi Suzuki, Saitama (JP); Fumihiro Okazaki, Saitama (JP); Takeshi Anzai, Saitama (JP); Masahiro Sano, Saitama (JP); Junichirou Terazawa, Saitama (JP); Kazuhiko Horikoshi, Saitama (JP)

Correspondence Address: BUCHANAN, INGERSOLL & ROONEY PC, POST OFFICE BOX 1404, ALEXANDRIA, VA, 22313-1404, US

(73) Assignee: CALSONIC KANSEI CORPORATION, Saitama-shi, Saitama (JP)

(21) Appl. No.: 12/934,411

(22) PCT Filed: Mar. 26, 2009
(86) PCT No.: PCT/JP2009/056036

§ 371 Date: Nov. 2, 2010

(30) Foreign Application Priority Data
Mar. 26, 2008 (JP) 2008-079845
Jun. 13, 2008 (JP) 2008-155056

(51) Int. Cl. H02G 3/02

(52) U.S. Cl. 307/9.1

(57) ABSTRACT

A vehicle wire harness portion (4) is disposed along a metallic vehicle body reinforcing member (3) installed in a vehicle body, and the vehicle wire harness portion (4) includes an integrated power supply wire portion (20) connected to an in-vehicle battery (6) so as to be capable of constantly applying a current and configured to be capable of applying a downstream load current, and a power distribution portion (21) connected to the integrated power supply wire portion (20).

### TECHNICAL FIELD

The present invention relates to a vehicle wire harness portion structure.

### BACKGROUND ART

In a vehicle such as an automobile, a metallic vehicle body reinforcing member is installed in a vehicle body to reinforce the vehicle body. For example, as shown in FIG. 6, a vehicle body reinforcing member 3 which is extended approximately in a direction 2 of a width of a vehicle and configured to connect between right-and-left vehicle body panels is installed in an interior portion of an instrument panel 1 which is installed in a forward portion of an interior of the vehicle (a vehicle-interior forward portion component or a vehicle-interior forward portion interior panel). The vehicle body reinforcing member 3 is referred to as a steering support member, a cross car beam, or the like, and normally formed by a metallic tubular member (such as an iron pipe).

Normally, a vehicle wire harness portion 4 is disposed approximately along the metallic vehicle body reinforcing member 3. The vehicle wire harness portion 4 has various electric wires which are capable of supplying an electrical power and a signal to each of parts of a vehicle body. For example, the vehicle wire harness portion 4 like this is referred to as a main harness and the like, and normally constituted of a bundle of a great number of electric wires (a vinyl-covered electric wire and a shielded electric wire).

FIG. 7 illustrates a configuration of such a conventional vehicle wire harness portion.

That is to say, in FIG. 7, an in-vehicle battery 6 is connected to a fuse box 8 via one electric wire for power supply (an electric wire for a high current) 7. Further, normally, the in-vehicle battery 6 is provided in an engine room, and the fuse box 8 is provided in the interior of the vehicle (such as the interior portion or a lower portion of the instrument panel 1). A power supply converting portion 11 (a power supply converting circuit portion) and a fuse portion 12 connected to the power supply converting portion 11 are provided in an interior portion of the fuse box 8. One or more than one fuse portion 12 is connected to the power supply converting portion 11. Furthermore, a plurality of such combinations of the power supply converting portion 11 and the fuse portion 12 are provided in parallel.

A power of the one electric wire for the power supply (the electric wire for the high current) 7 mentioned above is converted and distributed according to a plurality of individual electric wires for power supply (electric wires for a low current) 13 of which current values and modes for applying a current are different in each of the power supply converting portions 11 of the fuse box 8. A plurality of the individual electric wires for the power supply (the electric wires for the low current) 13 for each of which the power is converted and distributed in this manner, and other electric wires are bundled together, and thereby the vehicle wire harness portion 4 mentioned above is constituted.

In recent years, the vehicle wire harness portion 4 like this, which is constituted of the bundle of the electric wires, is directly housed in a case (for example, refer to Patent Document 1), or a harness portion is formed as a substrate to be housed in a case, and thereby a module (a so-called harness module) is formed (for example, refer to Patent Document 2).

In this manner, the vehicle wire harness portion 4 is housed in the case or modularized (to be the harness module), and thereby it is expected that downsizing of the vehicle wire harness portion 4, in particular a small size in diameter thereof, easy assembling of the vehicle wire harness portion 4, and so on can be achieved.

Patent Document 1: Japanese Patent No. 3390519

Patent Document 2: Japanese Laid-open Patent Publication No. 2006-205979

### DISCLOSURE OF INVENTION

### Problems to be Solved by the Invention

However, by automation of a vehicle in recent years, since the number of vehicle-mounted electrical components is increased, the number of electric wires constituting a vehicle wire harness portion 4 is also increased. In particular, the number of shielded wires, of which a diameter is large, as a countermeasure against noise is significantly increased. Therefore, the vehicle wire harness portion 4 has become larger in diameter and grown in size.

Therefore, although the vehicle wire harness portion 4 is housed in a case or modularized as mentioned above to achieve a small size in diameter and downsizing of the vehicle wire harness portion 4, the case which houses and holds the vehicle wire harness portion 4 may be pressed by the harness portion and damaged even in this circumstance. In addition, since a periphery of a vehicle body reinforcing member 3 of an interior portion of an instrument panel 1 is in an overcrowded condition due to components, it is difficult to take a measure to increase the stiffness of the case, for example, to increase the wall thickness of the case.

An object of the present invention is to provide a vehicle wire harness portion structure of which adequate strength can be achieved and assembling is easy, in spite of the fact that the vehicle wire harness portion can be downsized and become smaller in diameter.

### Means to Solve the Problems

In order to achieve the above object, in a vehicle wire harness portion structure according to an embodiment of the present invention, a vehicle wire harness portion is disposed along a vehicle body reinforcing member installed in a vehicle body, and the vehicle wire harness portion includes an integrated power supply wire portion connected to an in-vehicle battery so as to be capable of constantly applying a current and configured to be capable of applying a downstream load current, and a power distribution portion connected to the integrated power supply wire portion.

In a vehicle wire harness portion structure according to another embodiment of the present invention, a vehicle wire harness portion which has a plurality of power transmission paths is disposed along a vehicle body reinforcing member installed in a vehicle body, the vehicle wire harness portion is formed as a substrate and thereby a harness substrate is structured, and the harness substrate comprises a main substrate and a sub-substrate which are separately provided from each other.

### BRIEF DESCRIPTION OF DRAWINGS

FIG. 1 is a circuit configuration diagram of a vehicle wire harness portion structure according to a first embodiment of the present invention.

FIG. 2 is a view illustrating an assembled state of a vehicle wire harness portion in FIG. 1 to a vehicle body reinforcing member.

FIG. 3 is an exploded perspective view of FIG. 2.

FIG. 4 is a cutaway view of a main harness portion in FIG. 3.

FIG. 5 is an exploded perspective view of a vehicle wire harness portion structure according to a second embodiment of the present invention.

FIG. 6 is an exploded perspective view of a portion of an instrument panel which is used for an explanation of a conventional example and the present invention.

FIG. 7 is a circuit configuration diagram illustrating a conventional vehicle wire harness portion structure.

### BEST MODE FOR CARRYING OUT THE INVENTION

Hereinafter, best mode for carrying out the present invention will be explained in detail with reference to the accompanying drawings based on a preferred embodiment.

### First Embodiment

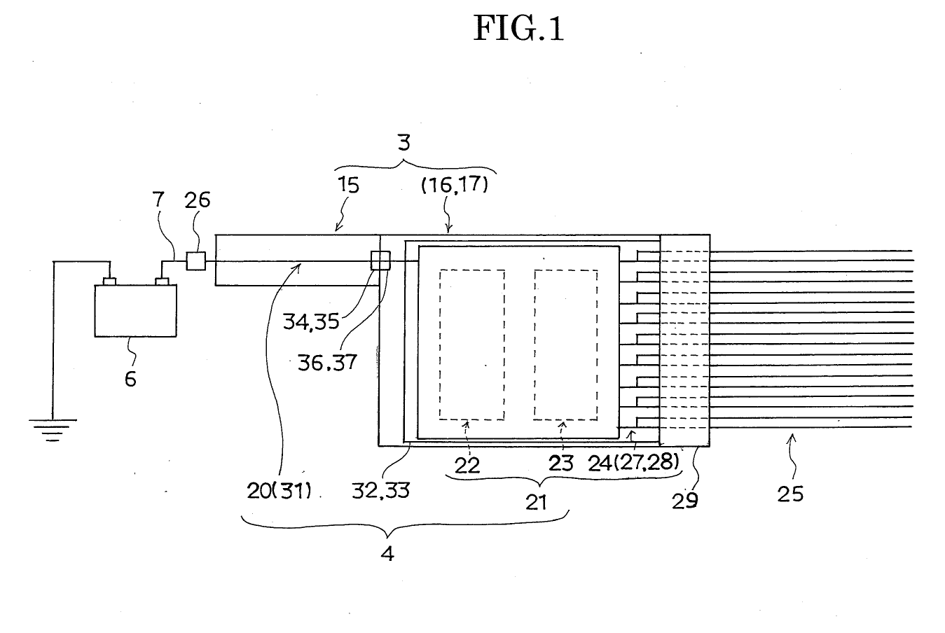

FIGS. 1 to 4 illustrate a vehicle wire harness portion structure according to a first embodiment of the present invention.

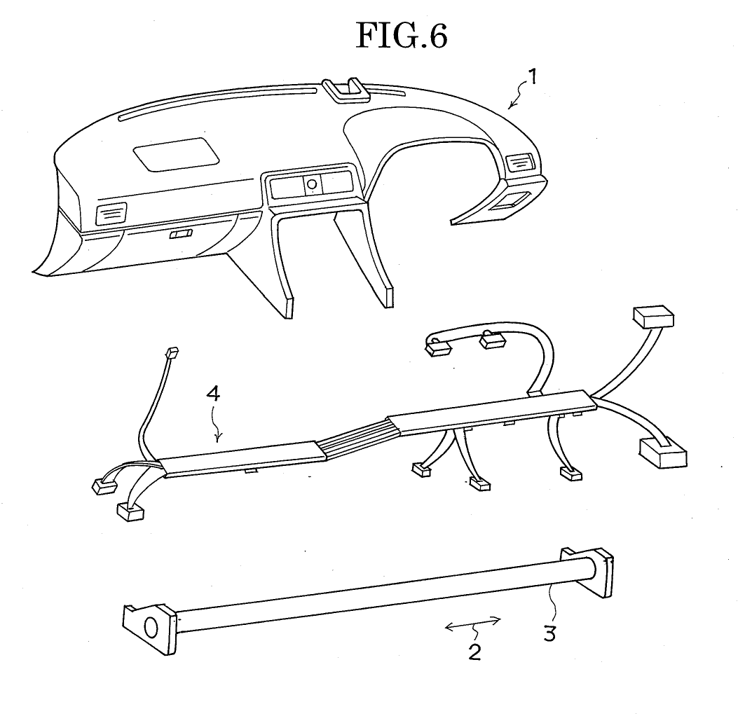

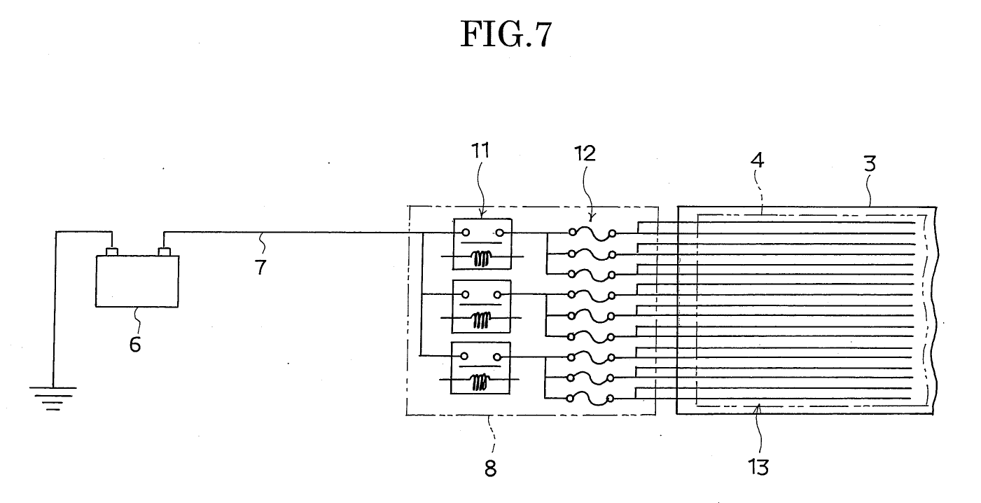

In addition, in the vehicle wire harness portion structure according to the present invention, the same reference numbers as those in FIG. 6 and FIG. 7 are used for parts similar to conventional structures shown in FIG. 6 and FIG. 7.

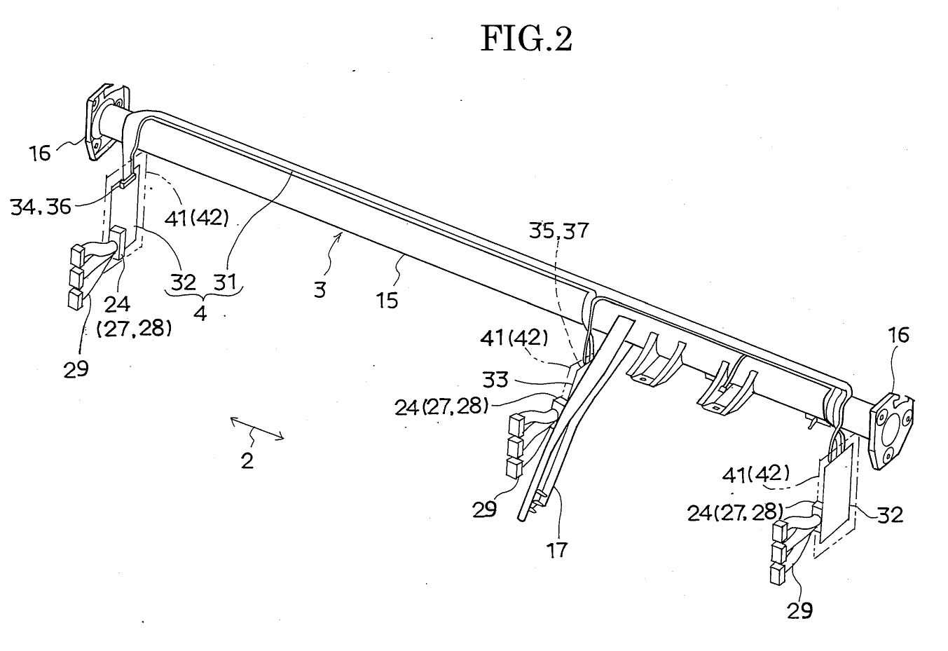

The vehicle wire harness portion structure in the first embodiment has a vehicle wire harness portion 4 which is disposed along a vehicle body reinforcing member 3 and configured to supply an electrical power and a signal to each of parts of a vehicle body by being connected to an in-vehicle battery 6 (refer to FIG. 2).

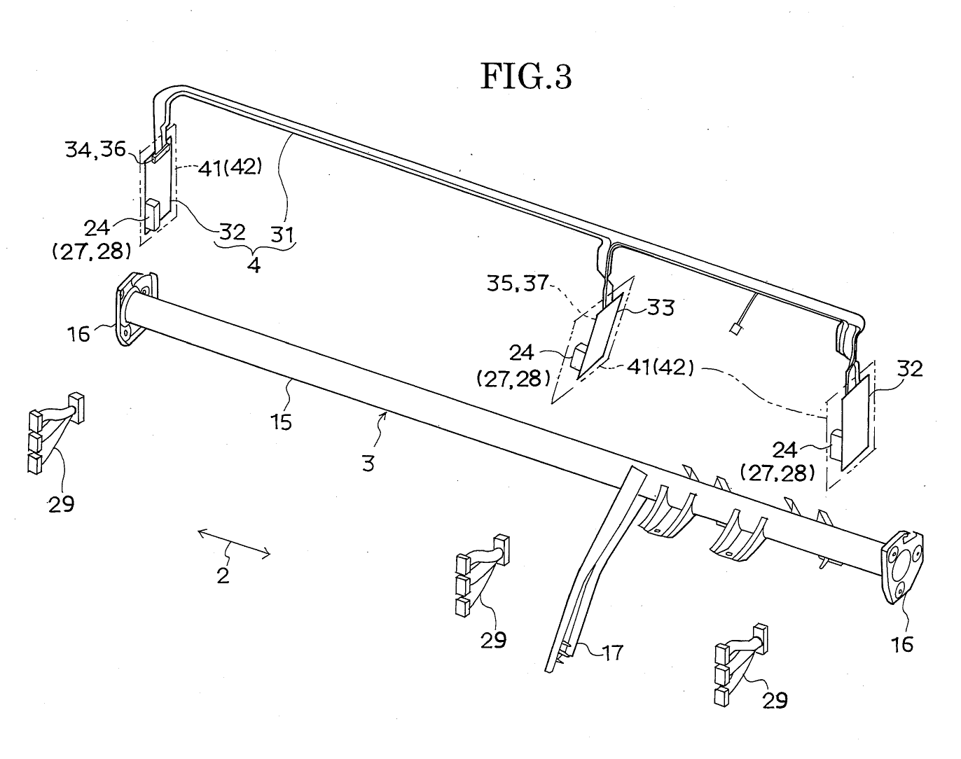

The vehicle body reinforcing member 3 comprises a vehicle body reinforcing member component including a vehicle-body reinforcing member body 15 extended approximately in a direction 2 of a width of a vehicle, a (right-and-left) pair of side brackets 16 provided to both end portions of the vehicle-body reinforcing member body 15, and a stay 17 provided to a middle portion of the vehicle-body reinforcing member body 15 as shown in FIG. 2 and FIG. 3 in this embodiment.

The vehicle-body reinforcing member body 15 comprises a hollow reinforcing member extended approximately in the direction 2 of the width of the vehicle in this embodiment. The side brackets 16 have a function as a mounting member to mount the vehicle-body reinforcing member body 15 on right-and-left vehicle body panels which are not shown in a drawing. The stay 17 has a function as a supporting member to support the middle portion of the vehicle-body reinforcing member body 15 against a floorboard panel, which is not shown in a drawing, of the vehicle body. The stay 17 has a supporting strut extended approximately downward from a downside of the vehicle-body reinforcing member body 15 to the floorboard panel. Although one stay 17 is provided in the embodiment shown in the drawing, a plurality of the stays may be provided.

The vehicle wire harness portion 4 includes, as shown in FIG. 1, an integrated power supply wire portion 20 connected to the in-vehicle battery 6 so as to be capable of constantly applying a current and configured to be capable of applying a downstream load current, and a power distribution portion 21 connected to the integrated power supply wire portion 20.

Here, the in-vehicle battery 6 is normally provided in an engine room. A cutout switch 26 may be provided, as needed, in the middle of an electric wire for a high current 7 which connects the in-vehicle battery 6 and the integrated power supply wire portion 20 of the vehicle wire harness portion 4. Further, it is desirable that the integrated power supply wire portion 20 have, for example, a current capacity which is equal to or more than 30 A so as to be capable of applying the downstream load current.

The power distribution portion 21 includes, in this embodiment, a power supply converting functional portion 22, an auto fuse portion 23 having an automatically recoverable fuse (that is to say, in which a fuse replacement is not needed), and a connecting part 24. The power supply converting functional portion 22 comprises, for example, a power supply converting circuit which is capable of converting and distributing a power according to a plurality of power transmission paths of which modes for applying a current and current values are different. It is desirable that, for example, the auto fuse portion 23 include various electronic fuses installed on the power transmission paths for each of which the power is converted and distributed in the power supply converting functional portion 22, integrate these fuses, and further, have a function to control each of the fuses. In this case, the integrated power supply wire portion 20 and the auto fuse portion 23 may be prepared separately in advance and combined to be one circuit, or provided together on one semiconductor of a POWER MOS and the like as shown in the drawing.

The connecting part 24, although it is not specifically shown in the drawing, may have a connector portion 27 to connect an external vehicle wire harness portion 25, a connector portion 28 to be directly connected to an external electrical component and so on at a downstream side and may function as a circuit branching portion. The power supply converting functional portion 22, the auto fuse portion 23, and the connecting part 24 may be connected in order from an upstream side as a circuit and also have a structure in which the power supply converting functional portions 22, the auto fuse portions 23 and the connecting parts 24 may be provided in parallel. In addition, since the external vehicle wire harness portion 25 takes a form such as an assembled electric wire or an individual electric wire as appropriate, an auxiliary sub-harness 29 having an intermediate branching function, and the like may be configured to intervene between the connecting part 24 and the external vehicle wire harness portion 25 as needed. The sub-harness 29 has a connector portion to the connecting part 24 at one end portion thereof as well as a connector portion to the external vehicle wire harness portion 25 at the other end portion thereof, and may have a shape branched into a required number.

The vehicle wire harness portion 4 comprises, in this embodiment, as shown in FIG. 2 and FIG. 3, one main harness portion 31 and a plurality of sub-substrates 32, 33. The main harness portion 31 includes the integrated power supply wire portion 20 mentioned above, and each of the sub-substrates 32, 33 has a configuration including the power supply converting functional portion 22, the auto fuse portion 23 having the automatically recoverable fuse, and the connecting part 24, which are mentioned above.

Here, connector portions 34, 35 for connecting to the sub-substrates 32, 33 are further provided in the main harness portion 31, respectively. Meanwhile, connector portions 36, 37 for connecting are further provided in the sub-substrates 32, 33, respectively. The connector portions 36, 37 are capable of being attached to the connector portions 34, 35 in the main harness portion 31, respectively. The main harness portion 31 and each of the sub-substrates 32, 33 are configured to be capable of being connected via the connector portions 34 to 37.

Further, it is desirable that the vehicle wire harness portion 4 have a configuration which is capable of corresponding to a configuration of the vehicle body reinforcing member 3. That is to say, the main harness portion 31 and each of the sub-substrates 32, 33 constituting the vehicle wire harness portion 4 have such a configuration that they are capable of being provided corresponding to the vehicle body reinforcing member components such as the vehicle-body reinforcing member body 15, the side brackets 16, and the stay 17.

For example, the main harness portion 31 is disposed along the vehicle-body reinforcing member body 15, and the sub-substrates 32, 33 are configured to be attached to the side brackets 16 and the stay 17. Therefore, only the sub-substrates 32, 33, the number of which is matched to the number of the side brackets 16 and the stay 17, are configured to be provided. In this case, a sub-bracket or the like, which is not shown in a drawing, to mount the sub-substrate 32 thereon may be configured to be provided on the side bracket 16. Furthermore, the configuration is set so that three sub-substrates 32, 33 are provided in a case of the one stay 17, and four sub-substrates 32, 33 are provided in a case of two stays 17. In addition, the sub-substrates 32, 33 may be also configured to be provided to the vehicle body reinforcing member components other than the side brackets 16 and the stay 17 which are mentioned above.

In the above, all of power transmission paths other than the above are incorporated in the main harness portion 31 to be united to form an integrated harness portion.

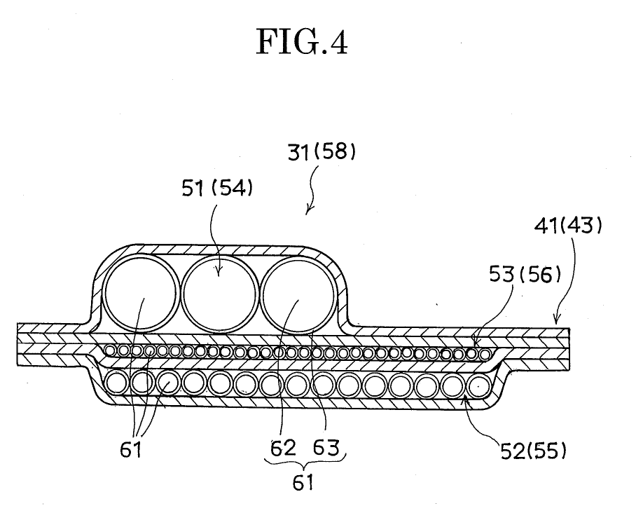

All of the power transmission paths other than the above include, for example, an electric wire for a low current (a drive circuit), having a current capacity of not more than 30 A but not less than 15 A, an electric wire for a signal (a control circuit), and so on, which have been previously considered as not specifically contributing to downsizing. These will be described hereinafter (for example, refer to reference numbers 52, 53 and so on of FIG. 4).

In the above, a whole of the vehicle wire harness portion 4 or at least a main section of the vehicle wire harness portion 4 may be configured to be covered with a shielding device 41 (refer to FIG. 4).

In this case, it is desirable that almost all the main harness portion 31 and the sub-substrates 32, 33 be configured to be covered with the shielding device 41.

The shielding device 41 may be configured by using, for example, a metallic case 42 (refer to FIG. 2), a sheet-shaped metallic material 43 (refer to FIG. 4) and so on. Further, as a whole or a part of the shielding device 41, the vehicle body reinforcing member 3 (the vehicle body reinforcing member components such as the vehicle-body reinforcing member body 15, the side brackets 16, and the stay 17) may be used as well.

In FIG. 2, for example, the shielding device 41 has a configuration in which the sub-substrates 32, 33 are configured to be housed in the metallic case 42. Here, the metallic case 42 is configured as a separate body from the vehicle body reinforcing member 3. However, the metallic case 42 may be provided approximately in a unified state to the vehicle body reinforcing member 3. Further, the connecting part 24 (the connector portions 27, 28) and the connector portions 36, 37 need to be configured to be exposed from the metallic case 42 so as to be capable of being externally accessed. Furthermore, in FIG. 4, the main harness portion 31 is enclosed with the sheet-shaped metallic material 43 so as to be packaged. This will be described hereinafter.

In the above-mentioned configuration, power transmission paths installed in the main harness portion 31 are, as shown in FIG. 4, sorted into at least three types of a power transmission path for a high current 51, a power transmission path for a low current 52, and a power transmission path for a signal 53. The power transmission paths in each type are disposed so as to be planar, and form each of planar power transmission path groups 54 to 56. Further, each of the planar power transmission path groups 54 to 56 is individually covered with the shielding device 41. On that basis, they are further layered one upon another (a power transmission path layered body 58).

In this case, the integrated power supply wire portion 20 mentioned above corresponds to the power transmission path for the high current 51. Further, the electric wire for the low current and the electric wire for the signal, which are mentioned above, correspond to the power transmission path for the low current 52 and the power transmission path for the signal 53, respectively. Furthermore, the power transmission path for the high current 51, the power transmission path for the low current 52, and the power transmission path for the signal 53 are formed such that their diameters are different from each other according to differences of their current capacities. In this case, a diameter of the power transmission path for the high current 51 is the largest, a diameter of the power transmission path for the low current 52 is medium, and a diameter of the power transmission path for the signal 53 is the smallest.

In addition, regarding the power transmission paths for the high current 51, although not specifically shown in a drawing, a whole of the power transmission paths for the high current 51 may be configured to be united, and also a midstream branching portion to distribute the electrical power to each of the sub-substrates 32, 33 may be configured to be provided as appropriate (a united structure). Or, regarding the power transmission paths for the high current 51, the power transmission paths for the high current 51, the number of which corresponds to the number of the sub-substrates 32, 33, may be configured to be installed as shown in the drawing instead of the above-mentioned midstream branching portion being provided. In this embodiment, by employing the latter configuration, the three power transmission paths for the high current 51 are installed corresponding to the three sub-substrates 32, 33, respectively.

The planar power transmission path groups 54 to 56 may be individually disposed, however it is desirable for handling that they be bonded to each other so as to be united.

The sheet-shaped metallic material 43 is configured to be used for the shielding device 41 in this case. For example, aluminum foil, aluminum film which is made with resin film coated with aluminum, or the like is used for the sheet-shaped metallic material 43. Then, for example, in each of the planar power transmission path groups 54 to 56, an upper portion and a lower portion thereof may be configured to be sandwiched in the sheet-shaped metallic materials 43 and packaged by edge circumference portions thereof which are bonded to each other (an individual package). Then, they (the individual packages) may be configured to be further layered one upon another and packaged by edge circumference portions thereof which are bonded to each other (an individual package layered body). Further, in this embodiment, the sheet-shaped metallic materials 43 are configured to be disposed to an upper portion, to a lower portion, and so as to intervene in interlayers of the planar power transmission path groups 54 to 56 which are disposed so as to be layered one upon another, and edge circumference portions of a plurality of the layered sheet-shaped metallic materials 43 are bonded to each other to be packaged, and thereby the sheet-shaped metallic materials 43 which are redundant in the interlayers are capable of being omitted (a simple package). Furthermore, in a necessary case, the simple package or the like which partially includes the individual package may be also formed. In addition, it is desirable that the connector portions 34, 35 be configured to be exposed from the interlayer of the sheet-shaped metallic materials 43 so as to be capable of being externally accessed.

Further, an order of a layered disposition of each of the planar power transmission path groups 54 to 56 may be specifically arbitrarily determined. In this embodiment, each of the planar power transmission path groups 54 to 56 is disposed so as to be layered one upon another into three layers so that the power transmission paths for the high current 51 are to be an upper layer, the power transmission paths for the signal 53 are to be a middle layer, and the power transmission paths for the low current 52 are to be a lower layer. By the above-mentioned configuration, the main harness portion 31 mentioned above is to have a flat shape of a thin type.

In the above-mentioned configuration, a magnet wire 61 may be used as the power transmission path.

Here, the magnet wire 61 is an inclusive term of the power transmission paths which may be used for an electromagnetic coil and so on. The magnet wire 61 may be used for all of the power transmission path for the high current 51, the power transmission path for the low current 52, and the power transmission path for the signal 53.

An enameled wire, for example, may be used for the magnet wire 61. Generally, the enameled wire is what insulating paint is applied to a circumference of a conductive wire 62 (a core wire), further as needed, a baking treatment is performed, and thereby an insulating coat 63 is configured to be formed on an outer circumference of the conductive wire 62. For the normal enameled wire, a copper wire is used for the conductive wire 62, and insulating varnish is used for the insulating paint. However, the conductive wire 62 and the insulating paint may be substituted with materials which have functions equivalent to the copper wire and the insulating varnish, respectively. The enameled wire like this uses the extremely thin insulating coat 63 with the insulating paint, and thereby can have a small diameter dimension as well as a high insulation characteristic, a high corrosion-resistant characteristic, and a high resistance to acids. In addition, the enameled wire is generally recognized as being completely different from a normal (vinyl) covered electric wire in a structure as well as in a radial dimension (largeness of the diameter).

By the above-mentioned configuration, in the vehicle wire harness portion 4 installation structure in which the vehicle wire harness portion 4, which has at least one power transmission path, is disposed approximately along the metallic vehicle body reinforcing member 3 installed in the vehicle body, the vehicle wire harness portion 4 includes the integrated power supply wire portion 20 connected to the in-vehicle battery 6 so as to be capable of constantly applying the current and configured to be capable of applying the downstream load current and the power distribution portion 21 connected to the integrated power supply wire portion 20, and thereby the vehicle wire harness portion 4 is connected to the in-vehicle battery 6 so as to be capable of constantly applying the current. Further, the integrated power supply wire portion 20 (the power transmission path for the high current 51) configured to be capable of applying the downstream load current is installed, and thereby it becomes possible to integrate a power supply system which has not been integrated so far. Therefore, a simplified power supply system and an improved spliceless power supply system (ₐₙ improvement of a spliced state of an electric wire) can be achieved. Furthermore, by the integrated power supply wire portion 20, it is possible to eliminate the need in which a great number of individual power supply wire portions (the power transmission paths for the low current 52), which have been a factor of a large size in diameter and a growing in size of the vehicle wire harness portion 4 so far, are installed all in an unchanged form. Therefore, a small size in diameter and downsizing of the vehicle wire harness portion 4 can be fundamentally achieved. In addition, since it is possible to reduce the individual power supply wire portions by the integrated power supply wire portion 20 as mentioned above, a connector and the like can be downsized as well.

Meanwhile, the vehicle wire harness portion 4 includes the power distribution portion 21, and thereby it becomes possible to eliminate a fuse box and the like provided outside as well as convert and distribute the power of the integrated power supply wire portion 20 according to the individual power supply wire portions (the power transmission paths for the low current 52), in the vehicle wire harness portion 4. Therefore, it can be easily dealt with even in a case where the number of the electrical components is increased.

The vehicle wire harness portion 4 comprises the one main harness portion 31 and a plurality of the sub-substrates 32, 33. The main harness portion 31 includes the integrated power supply wire portion 20, and also each of the sub-substrates 32, 33 includes the power distribution portion 21. Therefore, it is possible to reasonably provide a configuration and a disposition of the vehicle wire harness portion 4. For example, the vehicle wire harness portion 4 may be matched with a configuration of the vehicle body reinforcing member 3, and thereby the configuration of the vehicle wire harness portion 4 can be more compactly organized and functionally-differentiated, and also the vehicle wire harness portion 4 can be reasonably installed on the vehicle body reinforcing member 3.

Further, the main harness portion 31 includes the integrated power supply wire portion 20, and also each of the sub-substrates 32, 33 includes the power distribution portion 21, and thereby the vehicle wire harness portion 4 can be furthermore reasonably functionally-differentiated than the above. Furthermore, the number of the power transmission paths which connect between the main harness portion 31 and the sub-substrates 32, 33 can be significantly reduced, and the main harness portion 31 and each of the sub-substrates 32, 33 can be connected with one small connector. In addition, since an electricity distribution between the vehicle wire harness portion 4 and each of external electronic components may be performed in a similar manner as before via each of the sub-substrates 32, 33 and the like, a handling ability thereof is unchanged and convenient.

All of the power transmission paths other than the power transmission path of the main harness portion 31 and power transmission paths between the main harness portion and the sub-substrates 32, 33 are incorporated in the main harness portion 31 to be united, and thereby it is not necessary to provide another wire harness portion and the like (such as a sub-harness) outside, it becomes possible to unite the vehicle wire harness portion 4, and the significant downsizing (a volume lowering) as a whole of the vehicle wire harness portion 4 and reducing the used amount of copper and the like by reducing of the number of electric wires become possible.

In the above-mentioned configuration, a whole or a part of the vehicle wire harness portion 4 is covered with the shielding device 41, and thereby it is possible to eliminate an effect of vehicle interior noise. Therefore, an expensive shielded electric wire and the like which has been needed so far can be eliminated or replaced with a general power transmission path. Further, it becomes possible also for the general power transmission path to obtain a shielding effect by the shielding device 41. The vehicle wire harness portion 4 is covered with the shielding device 41, and thereby it is possible to prevent re-radiation from the vehicle body reinforcing member 3 of noise coming through the power transmission path. Therefore, the noise does not affect the external electrical component.

In the above-mentioned configuration, the power transmission paths installed in the vehicle wire harness portion 4 are sorted into the at least three types of the power transmission path for the high current 51, the power transmission path for the low current 52, and the power transmission path for the signal 53, the power transmission paths in each type are disposed so as to be planar and form each of the planar power transmission path groups 54 to 56, and also each of the planar power transmission path groups 54 to 56 is layered one upon another in a state where each of the planar power transmission path groups 54 to 56 is individually covered with the shielding device 41.

Accordingly, the power transmission paths for the high current 51, the power transmission paths for the low current 52, and the power transmission paths for the signal 53, which are sorted into the at least three types, are disposed in each type so as to be planar, and thereby it is possible to obtain the planar power transmission path groups 54 to 56 of the thin type of which a shape, a purpose, and so on are consistent. Further, each of the planar power transmission path groups 54 to 56 is individually covered with the shielding device 41, and thereby it is possible to obtain each of the planar power transmission path groups 54 to 56 which are reliably shielded with the shielding device 41 individually. Furthermore, each of the reliably shielded planar power transmission path groups 54 to 56 is layered one upon another, and thereby the planar power transmission path groups 54 to 56 can be the power transmission path layered body 58 or the like which is the thin type and united. Therefore, the vehicle wire harness portion 4 can be further efficiently downsized, planarized, and also improved in a handling ability thereof.

In the above-mentioned configuration, the magnet wire 61 is used as the power transmission path, and thereby a following function effect can be obtained.

That is to say, since the magnet wire 61 has an extremely small diameter compared to the normal vinyl-covered electric wire, the normal shielded electric wire, and so on, the significant downsizing (the volume lowering) of the vehicle wire harness portion 4, and a reduction in the used amount of copper and the like, and so on can be achieved. Therefore, it becomes possible to deal also with an increase of the number of the power transmission paths efficiently.

### Second Embodiment

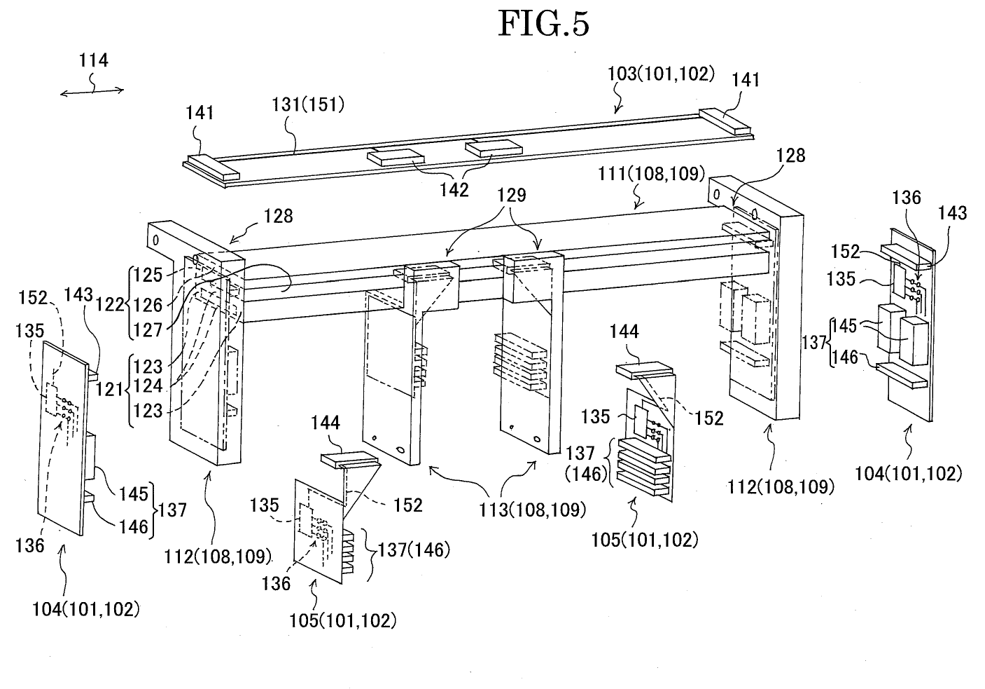

FIG. 5 illustrates a vehicle wire harness portion structure according to a second embodiment of the present invention.

In a vehicle wire harness portion structure according to the second embodiment, a vehicle wire harness portion 101 is formed as a substrate, and thereby a harness substrate 102 is structured. In such a circumstance, the harness substrate 102 comprises, for example, one main substrate 103 and four sub-substrates 104, 105 which are separately provided from each other (a decentralized substrate configuration) in this embodiment. Here, it should be noted that the number of the main substrate 103 and the sub-substrates 104, 105 is not limited to that in this embodiment and may be set arbitrarily.

At least one of the one main substrate 103 and the four sub-substrates 104, 105 is configured to be covered with a covering device, for example, a metallic case or a vehicle body reinforcing member 108.

Here, the metallic case is configured as a separate body from the vehicle body reinforcing member 108 in this embodiment. However, this metallic case may be provided approximately in a unified state to the vehicle body reinforcing member 108. Further, in this case, since the vehicle body reinforcing member 108 is to be used, the metallic case is not specifically shown in a drawing. Furthermore, it is most desirable that the one main substrate 3 and the four sub-substrates 104, 105 be configured to be all covered with the metallic case or the vehicle body reinforcing member 108.

Mainly, in a case of being covered with the vehicle body reinforcing member 108, the at least one of the one main substrate 103 and the four sub-substrates 104, 105 is configured to be housed in a vehicle body reinforcing member component 109 constituting the vehicle body reinforcing member 108.

Further, it is most desirable that the one main substrate 103 and the four sub-substrates 104, 105 be configured to be all housed in the vehicle body reinforcing member component 109 constituting the vehicle body reinforcing member 108.

Here, the vehicle body reinforcing member component 109 normally includes a vehicle-body reinforcing member body 111, a (right-and-left) pair of side brackets 112 provided to both end portions of the vehicle-body reinforcing member body 111, and a (right-and-left) pair of stays 113 provided to a middle portion of the vehicle-body reinforcing member body 111.

The vehicle-body reinforcing member body 111 is a hollow beam-like reinforcing member extended approximately in a direction 114 of a width of a vehicle. Further, the side brackets 112 mainly have a function as a mounting member to right-and-left vehicle body panels which are not shown in a drawing. The side brackets 112 are to be mounting brackets and the like. The stays 113 mainly have a function as a support-mount member to be mounted as well as support a middle portion of the vehicle-body reinforcing member body 111 against a floorboard panel which is not shown in a drawing. The stays 113 have supporting struts extended approximately downward from a downside of the vehicle-body reinforcing member body 111 to the floorboard panel.

The main substrate 103 mentioned above is housed in the vehicle-body reinforcing member body 111. Further, two sub-substrates 104 out of the four sub-substrates 104, 105 mentioned above are housed respectively in the pair of the side brackets 112. In a similar manner, two sub-substrates 105 out of the four sub-substrates 104, 105 are housed respectively in the pair of the stays 113.

In addition, although the same reference numbers are to be used, for convenience, to right and left of the two sub-substrates 104, the two sub-substrates 105, the pair of the side brackets 112, and the pair of the stays 113, respectively, the right and left thereof do not need to be completely the same or symmetrical.

In order that the main substrate 103 be configured to be housed in the vehicle-body reinforcing member body 111 as mentioned above, the vehicle-body reinforcing member body 111 is configured to have a hollow closed cross-section portion 121 (a strength ensuring portion) which is capable of ensuring strength, and an open cross-section portion 122 (a main substrate housing portion) which is capable of housing the main substrate 103.

In this case, the closed cross-section portion 121 is formed into a cross-section rectangle having front and back surfaces 123 and upper and lower surfaces 124. The closed cross-section portion 121 has a flattened rectangular shape so that areas of the upper and lower surfaces 124 are broadened.

Further, the open cross-section portion 122 is installed on an upper portion of the closed cross-section portion 121 to be united. The open cross-section portion 122 has one of a front wall 125 or a back wall, and an upper wall 126, and presents with an L-shaped surface, when viewed from a side, constituting a slit-like insertion portion 127, in which the main substrate 103 is capable of being inserted from a back side or a front side, between the upper wall 126 and the closed cross-section portion 121 (the upper side surface 124 thereof). Furthermore, the front or the back surface 123 of the closed cross-section portion 121 and the front wall 125 or the back wall of the open cross-section portion 122 are formed so as to be an approximately flat surface. Moreover, the upper side surface 124 of the closed cross-section portion 21 and the upper wall 126 of the open cross-section portion 122 are approximately the same size and formed in an approximately parallel manner. Therefore, the slit-like insertion portion 127 is formed in a slit-like space having an interstice which is approximately equal to a thickness of the main substrate 103 or slightly wider than the thickness.

By such a configuration, the vehicle-body reinforcing member body 111 presents with an approximately figure-6-shaped surface and the like, when viewed from a side, which has an approximately homogeneous cross-section across an entire length thereof. The metallic vehicle-body reinforcing member body 111 like this may be easily formed as one member by an extrusion and the like.

On the other hand, the main substrate 103 has a rectangular shape which extends in the direction 114 of the width of the vehicle and has a width dimension and a length dimension which are capable of being entirely housed in the slit-like insertion portion 27. The main substrate 103 comprises, for example, a both-surface copper-clad substrate.

Further, a housing portion which is capable of housing the sub-substrate 104 is provided to the side bracket 112. In a similar manner, a housing portion which is capable of housing the sub-substrate 105 is provided to the stay 113.

In this case, the side bracket 112 comprises a metallic bracket portion, a resin case portion provided to the bracket portion, and so on. Alternatively, the bracket portion is formed into a case shape, and also the bracket portion of the case shape is coated with resins (a resin case portion), and then a whole of the side bracket 112 may become a case structure portion. In addition, it is desirable that the bracket portion and the resin case portion be united by an insert molding.

Correspondingly, the sub-substrate 104 is configured to be capable of being housed and provided in the resin case portion. The sub-substrate 104 is configured to be formed with, for example, the both-surface copper-clad substrate. Alternatively, the side bracket 112 is set and adjusted so as to have a shape which is capable of housing the sub-substrate 104.

In a similar manner, the stay 113 comprises a metallic bracket portion, a resin case portion provided to the bracket portion, and so on. Alternatively, the bracket portion is formed into a case shape, and also the bracket portion of the case shape is coated with resins (a resin case portion), and then a whole of the stay 113 may become a case structure portion. In addition, it is desirable that the bracket portion and the resin case portion be united by the insert molding.

Correspondingly, the sub-substrate 105 is configured to be capable of being housed and provided in the resin case portion. The sub-substrate 105 is configured to be formed with, for example, a FPC (Flexible Printed Circuit). Alternatively, the stay 113 is set and adjusted so as to have a shape which is capable of housing the sub-substrate 105. In addition, in a case where the sub⁻substrate 105 is the FPC, since the sub-substrate 105 is thin, it is also possible to be provided so that the sub-substrate 105 is attached to the stay 113. Even in this manner, a function effect which is approximately similar to that in a case where the sub-substrate 105 is housed in the stay 113 can be obtained.

In a state where the main substrate 103 is housed in the vehicle-body reinforcing member body 111, where the two sub-substrates 104 are housed respectively in the pair of the side brackets 112, and where the two sub-substrates 105 are housed respectively in the pair of the stays 113, the pair of the side brackets 112 are configured to be capable of being attached respectively to the both end portions of the vehicle-body reinforcing member body 111, and also the pair of the stays 113 are configured to be capable of being attached respectively to the middle portion of the vehicle-body reinforcing member body 111. Attaching of the side brackets 112 to the vehicle-body reinforcing member body 111, and attaching of the stays 113 to the vehicle-body reinforcing member body 111 are respectively performed so as to be fixed by a fastening member such as a screw (a fastening fixed structure portion). In addition, a direction to fasten the side brackets 112 to the vehicle-body reinforcing member body 111 is to be the direction 114 of the width of the vehicle, and a direction to fasten the stays 113 to the vehicle-body reinforcing member body 111 is to be a direction along a length of the vehicle.

More specifically, the side bracket 112 is mainly configured to have a surface which is approximately orthogonal to the direction 114 of the width of the vehicle as well as an attaching portion 128 on an upper inside surface thereof, which is capable of being fixed so as to be in contact with an edge surface of the vehicle-body reinforcing member body 111.

Further, the stay 113 is mainly configured to have a surface which is approximately orthogonal to the direction 114 of the width of the vehicle as well as an attaching portion 129 on an upper portion thereof, which is capable of being fixed so as to be in contact with a surface (a front surface or a back surface) of the slit-like insertion portion 127 side of the vehicle-body reinforcing member body 111.

In addition, since the stays 113 are normally provided in pairs (two of them) to a driver side and a passenger side, the structure mentioned above is employed. However, there is also a structure in which only one stay 113 is provided. In a case where the one stay 113 is provided like this, three sub-substrates 104, 105 (two sub-substrates 104 for the side brackets 112 and one sub-substrate 105 for the stay 113) may be provided.

In a case of the decentralized substrate configuration, an integrated power supply circuit portion 131 is further provided in the main substrate 103. Meanwhile, a power supply converting functional portion 135, an auto fuse portion 136 having an automatically recoverable fuse, and a connecting part 137 are provided in each of the sub-substrates 104, 105.

Here, connector portions 141, 142 for connecting to the sub-substrates 104, 105 are further provided in the main substrate 103, respectively. Among them, the connector portions 141 are provided in positions corresponding to the attaching portions 128 of the side brackets 112, on both end portions of the main substrate 103. Further, the connector portions 142 are provided in positions corresponding to the attaching portions 129 of the stays 113, on a center portion of the main substrate 103. Meanwhile, connector portions 143, 144 for connecting are further provided in the sub-substrates 104, 105, respectively. The connector portions 143, 144 are capable of being attached to the connector portions 141, 142 in the main substrate 3, respectively. The connector portions 143, 144 are capable of performing functions of positioning and temporarily maintaining the position by being attached to the connector portions 141, 142 when the side brackets 112 and the stays 113 are attached to the vehicle-body reinforcing member body 111. In addition, an attaching direction of the connector portions 141, 143 in portions of the side brackets 112 is the direction 114 of the width of the vehicle, and an attaching direction of the connector portions 142, 144 in portions of the stays 113 is the direction along the length of the vehicle.

The power supply converting functional portion 135 in each of the sub-substrates 104, 105 may comprise, for example, a power supply converting circuit which is capable of converting and distributing a power according to a plurality of power transmission paths of which current values and modes for applying a current are different. Further, the auto fuse portion 136 may, for example, integrate various electronic fuses installed on the power transmission paths for each of which the power is converted and distributed in the power supply converting functional portion 135, and control each of the fuses. The connecting part 137 may include, as appropriate, a connector portion 145 (on the sub-substrate 104) to connect an external vehicle wire harness portion, a connector portion 146 (on the sub-substrates 104, 105) to be directly connected to an external electrical component, and so on. The connector portions 143, 144, the power supply converting functional portion 135, the auto fuse portion 136, and the connecting part 137 are connected in series in order from an upstream side. In addition, the connector portions 145, 146 are configured to be mounted on the side brackets 112 and the stays 113 in an outwardly opened state.

A conductor having a conductor cross-section area which is capable of being applied with a downstream load current is installed as an integrated power supply wire 151 in the integrated power supply circuit portion 131 of the main substrate 103.

Here, the integrated power supply wire 151 in the main substrate 103 is connected via, although not specifically shown in a drawing, a cutout switch from an in-vehicle battery in a state where the in-vehicle battery is capable of constantly applying a current and is capable of constantly transmitting the electrical power. The integrated power supply wire 151 extends approximately in a direction of a length of the main substrate 103 (the direction 114 of the width of the vehicle) as well as being connected to each of the connector portions 141, 142. Further, as to the sub-substrates 104, 105, conductors each has a conductor cross-section area which is capable of being applied with the downstream load current. The conductors are similar to the above, and installed as an integrated power supply wire 152 in parts between the connector portions 143, 144 and the power supply converting functional portions 135, respectively.

Further, all the rest of electric wires and so on which are not formed as the substrate are configured to be incorporated in the main substrate 103. As the rest of the electric wires and so on which are not formed as the substrate like this, there is, for example, a drive circuit which does not contribute to downsizing (such as a reduction of a conductor area by being formed as the substrate) and which applies a current which is equal to or more than 15 A.

As mentioned above, by modularizing the vehicle wire harness portion 101 (making the vehicle wire harness portion 101 be a harness module), downsizing of the vehicle wire harness portion 101, easy assembling of the vehicle wire harness portion 101 to the vehicle body reinforcing member 108, and so on can be achieved.

In a state where the main substrate 103 is housed in the vehicle-body reinforcing member body 111, where the two sub-substrates 104 are housed respectively in the pair of the side brackets 112, and where the two sub-substrates 105 are housed respectively in the pair of the stays 113, the pair of the side brackets 112 are respectively attached to the both end portions of the vehicle-body reinforcing member body 111, and also the pair of the stays 113 are respectively attached to the middle portion of the vehicle-body reinforcing member body 111, and thereby the main substrate 103 and the sub-substrates 104, 105 are connected at the same time.

As mentioned above, according to the present invention, the integrated power supply wire portion (the power transmission path for the high current) which is connected to the in-vehicle battery so as to be capable of constantly applying the current and configured to be capable of applying the downstream load current is installed in the vehicle wire harness portion, and thereby it becomes possible to integrate the power supply system which has not been integrated so far. Therefore, the simplified power supply system and the improved spliceless power supply system (the improvement of the spliced state of the electric wire) can be achieved. Further, by the integrated power supply wire portion, it is possible to eliminate the need in which a great number of the individual power supply wire portions (the power transmission paths for the low current), which have been the factor of the large size in diameter and the growing in size of the vehicle wire harness portion so far, are installed all in the unchanged form. Therefore, the small size in diameter and the downsizing of the vehicle wire harness portion can be fundamentally achieved. In addition, the connector and the like can be downsized, since it is possible to reduce the individual power supply wire portions by the integrated power supply wire portion as mentioned above. Meanwhile, the vehicle wire harness portion includes the power distribution portion, and thereby it becomes possible to eliminate the fuse box and the like provided outside as well as convert and distribute the power of the integrated power supply wire portion according to the individual power supply wire portions (the power transmission paths for the low current), in the vehicle wire harness portion. Therefore, it can be appropriately dealt with even in the case where the number of the electrical components is increased.

The vehicle wire harness portion comprises the one main harness portion and a plurality of the sub-substrates which are separately provided from each other, and thereby it is possible to reasonably provide the configuration and the disposition of the vehicle wire harness portion. For example, the vehicle wire harness portion is matched with the configuration of the vehicle body reinforcing member, and thereby the configuration of the vehicle wire harness portion can be more compactly organized and functionally-differentiated, and also the vehicle wire harness portion can be reasonably installed on the vehicle body reinforcing member. Further, the main harness portion is configured to include the integrated power supply wire portion, and also each of the sub-substrates includes the power distribution portion, and thereby the vehicle wire harness portion can be furthermore reasonably functionally-differentiated than the above. Furthermore, by the above, the number of the power transmission paths which connect between the main harness portion and the sub-substrates can be significantly reduced, and the main harness portion and each of the sub-substrates can be connected with the one small connector. In addition, since the electricity distribution between the vehicle wire harness portion and each of the external electronic components may be performed in a similar manner as before via each of the sub-substrates and the like, the handling ability thereof is unchanged and convenient.

All of the power transmission paths other than the power transmission path of the main harness portion and the power transmission paths of a plurality of the sub-substrates mentioned above are incorporated in the main harness portion to be united, and thereby it becomes unnecessary to provide another wire harness portion and the like (such as the sub-harness) outside, it becomes possible to unite the vehicle wire harness portion, and the significant downsizing (the volume lowering) as a whole of the vehicle wire harness portion and reducing the used amount of copper and the like by reducing of the number of the electric wires become possible.

The whole of the vehicle wire harness portion or the at least main section of the vehicle wire harness portion is covered with the shielding device, and thereby it is possible to eliminate the effect of the vehicle interior noise. Therefore, the expensive shielded electric wire and the like which has been needed so far can be eliminated or replaced with the general power transmission path. Further, it becomes possible also for the general power transmission paths to obtain the shielding effect by the shielding device. The vehicle wire harness portion is covered with the shielding device, and thereby it is possible to prevent the re-radiation from the vehicle body reinforcing member of the noise coming through the power transmission path. Therefore, the noise does not affect the external electrical component.

The power transmission paths for the high current, the power transmission paths for the low current, and the power transmission paths for the signal, which are sorted into the at least three types, are disposed in each type so as to be planar, and thereby it is possible to obtain the planar power transmission path groups of the thin type of which the shape, the purpose, and so on are consistent. Each of the planar power transmission path groups is individually covered with the shielding device, and thereby it is possible to obtain each of the planar power transmission path groups which are reliably shielded with the shielding device individually. Further, each of the reliably shielded planar power transmission path groups is layered one upon another, and thereby the planar power transmission path groups can be the power transmission path layered body or the like which is the thin type and united. Therefore, the vehicle wire harness portion can be further efficiently downsized, planarized, and also improved in the handling ability thereof.

Since the magnet wire has the extremely small diameter compared to the normal vinyl-covered electric wire, the normal shielded electric wire and so on, the significant downsizing (the volume lowering) of the vehicle wire harness portion, the reduction in the used amount of copper and the like, and so on can be achieved. Therefore, it becomes possible to deal also with the increase of the number of the power transmission paths easily.

The harness substrate comprises the main substrate and the sub-substrates which are separately provided from each other, and thereby the configuration and the disposition of the harness substrate can be reasonably provided so as to be matched with the configuration of the vehicle body reinforcing member, and also the configuration of the harness substrate can be more compactly organized and functionally-differentiated.

At least one of the main substrate and the sub-substrates is covered with the metallic case or the sheet-shaped metallic material, and thereby it is possible to eliminate the effect of the vehicle interior noise. Therefore, the shielded wire and the like which has been needed so far can be replaced with the general power transmission path. Further, the power transmission paths are all covered with metal (the metallic case or the vehicle body reinforcing member), and thereby it is possible to prevent the re-radiation from the vehicle body reinforcing member of the noise coming through the power transmission path. Therefore, the noise does not affect the external electrical component.

Since the harness substrate (the one main substrate and the four sub-substrates) is configured to be united with the vehicle body reinforcing member component, the harness substrate can be reasonably provided in the vehicle body reinforcing member, and also the assembling of the vehicle wire harness portion (the harness substrate) can be performed together at the same time of assembling of the vehicle body reinforcing member.

The integrated power supply circuit portion is provided in the main substrate, and thereby it becomes possible to integrate the power supply system which has not been integrated so far. Therefore, the simplified power supply system and the improved spliceless power supply system (the improvement of the spliced state) can be achieved. Further, as mentioned above, the number of the power transmission paths which connect between the main substrate and the sub-substrates can be significantly reduced. Therefore, each of the connections between the substrates (the main substrate and the sub-substrates) can be performed with one small connector. Furthermore, since an electricity distribution between the vehicle wire harness portion and each of external electronic components may be performed in a similar manner as before via each of the sub-substrates and the like, a handling ability thereof is convenient.

The conductor configured to be capable of applying the downstream load current is installed as the integrated power supply wire in the integrated power supply circuit portion, and thereby it becomes possible to incorporate a high-current circuit, which has not been capable of being formed as the substrate so far, in the substrate, and completely eliminate the conventional vehicle wire harness portion (a wire harness) using the electric wires. Further, by the integrated power supply wire, the number of a plurality of various power supply wires which have been installed so far can be reduced, and thus it also becomes possible to downsize the connector. Furthermore, the integrated power supply wire of the integrated power supply circuit portion may be directly connected via the cutout switch from the in-vehicle battery in a state of being capable of constantly applying the current.

All the rest of the electric wires and so on which are not formed as the substrate are incorporated in the main substrate, and thereby it becomes possible to incorporate all of the vehicle wire harness portion (the wire harness), which is made of the electric wires, successfully in the substrate, and the significant volume lowering and reducing the used amount of copper and the like by reducing of the number of electric wires for power supply become possible.

Although preferred embodiments of the present invention are described as mentioned above, the present invention is not limited to these embodiments, and it is to be understood that various sorts of variants and changes may be made in the embodiments.

1. A vehicle wire harness portion structure, in which a vehicle wire harness portion is disposed along a vehicle body reinforcing member installed in a vehicle body,
wherein the vehicle wire harness portion includes an integrated power supply wire portion connected to an in-vehicle battery so as to be capable of constantly applying a current and configured to be capable of applying a downstream load current, and a power distribution portion connected to the integrated power supply wire portion.

2. The vehicle wire harness portion structure according to claim 1, wherein
the vehicle wire harness portion comprises one main harness portion and a plurality of sub-substrates;
the main harness portion includes the integrated power supply wire portion; and
each of the sub-substrates includes the power distribution portion.

3. The vehicle wire harness portion structure according to claim 2, wherein
all of power transmission paths other than a power transmission path of the main harness portion and power transmission paths between the main harness portion and the sub-substrates are incorporated in the main harness portion to be united.

4. The vehicle wire harness portion structure according to claim 1, wherein
a whole or a part of the vehicle wire harness portion is covered with a shielding device.

5. The vehicle wire harness portion structure according to claim 2, wherein
power transmission paths installed in the main harness portion are sorted into at least three types of a power transmission path for a high current, a power transmission path for a low current, and a power transmission path for a signal;
the power transmission paths in each type are disposed so as to be planar, and form a planar power transmission path group; and
each of the planar power transmission path groups is layered one upon another in a state where each of the planar power transmission path groups is individually covered with a shielding device.

6. The vehicle wire harness portion structure according to claim 5, wherein
the power transmission path includes a magnet wire.

7. A vehicle wire harness portion structure, in which a vehicle wire harness portion having a plurality of power transmission paths is disposed along a vehicle body reinforcing member installed in a vehicle body,
wherein the vehicle wire harness portion is formed as a substrate, and thereby a harness substrate is structured; and
wherein the harness substrate comprises a main substrate and a sub-substrate which are separately provided from each other.

8. The vehicle wire harness portion structure according to claim 7, wherein
the harness substrate comprises one main substrate and four sub-substrates which are separately provided from each other.

9. The vehicle wire harness portion structure according to claim 7, wherein
at least one of the main substrate and the sub-substrates is covered with a covering device.

10. The vehicle wire harness portion structure according to claim 9, wherein
the covering device includes a metallic case or has a structure covering the at least one of the main substrate and the sub-substrates with the vehicle body reinforcing member.

11. The vehicle wire harness portion structure according to claim 7, wherein
at least one of the main substrate and the sub-substrates is housed in a vehicle body reinforcing member component constituting the vehicle body reinforcing member.

12. The vehicle wire harness portion structure according to claim 7, wherein
an integrated power supply circuit portion is provided in the main substrate; and
a power supply converting functional portion, an auto fuse portion having an automatically recoverable fuse, and a connecting part are provided in each of the sub-substrates.

13. The vehicle wire harness portion structure according to claim 12, wherein
a conductor configured to be capable of applying a downstream load current is installed as an integrated power supply wire in the integrated power supply circuit portion of the main substrate.

14. The vehicle wire harness portion structure according to claim 13, wherein
all the rest of electric wires which are not formed as the substrate are configured to be incorporated in the main substrate.
